(19) United States
(12) Patent Application Publication
(10) Pub. No.: US 2015/0254479 A1
(43) Pub. Date: Sep. 10, 2015

(54) Printing Device, Printing System, and Control Method of a Printing Device

(71) Applicant: Seiko Epson Corporation, Tokyo (JP)

(72) Inventor: Tomoharu Kifuku, Matsumoto-shi (JP)

(21) Appl. No.: 14/630,274

(22) Filed: Feb. 24, 2015

(30) Foreign Application Priority Data
Mar. 10, 2014 (JP) 2014-045995

(51) Int. Cl. G06K 1/12; G06F 3/12; G06K 15/02

(52) U.S. Cl. CPC G06K 1/121; G06K 15/1809; G06K 15/1868; G06F 3/1204; G06F 3/1254; G06F 3/1257

(57) ABSTRACT

A printing device, a printing system, and a control method of a printing device can easily adjust how a barcode is printed. The printer stores a constant for adjusting how to print a barcode in a printer storage unit, interprets commands received from a host computer, and acquires a specified additional adjustment value when the interpreted command is a command specifying an additional adjustment value. When a command instructing printing a barcode is received, the printer prints the barcode based on the previously stored constant and the additional adjustment value acquired from a command.

This application claims priority under 35 U.S.C. §119 to Japanese Patent Application No. 2014-045995 filed on Mar. 10, 2014, the entire disclosure of which is expressly incorporated by reference herein.

### BACKGROUND

1. Technical Field

The present disclosure relates to a printing device, a printing system, and a control method of a printing device

2. Related Art

Printing devices (printers) for printing barcodes are known from the literature. A barcode has a number of color bars separated by white space, and conforms to one of various standards such as JAN code, EAN, UPC code, ITF code, CODE39, CODE128, and NW-7. The widths of the bars and spaces are determined by the barcode standard, and devices that read the barcodes recognize bars and spaces of the widths defined by the particular standard.

When a barcode is printed with an inkjet printer, however, bar width can vary as a result of ink bleeding and deviation in where the ink droplets land on the printed surface. Reading a barcode may be difficult if the bar width deviates more than allowed by the standard. Addressing this problem, JP-A-2005-47169 and JP-A-2009-193428 disclose ways to change how a barcode is printed depending on the print medium used for printing. The device of JP-A-2005-47169 changes the dot configuration of the bars and spaces in the barcode according to the type of print medium based on a previously stored correction table. The printing system of JP-A-2009-193428 adjusts the widths of the bars in the barcode according to the type of paper.

There are, however, many different types of print media, and the characteristics of the print medium used by the user can easily differ from the print medium anticipated by the manufacturer of the printer. In this event, how the printer prints the barcode must be adjusted, and this increases the burden on the user operating the printer.

### SUMMARY

An objective of at least one embodiment of the present invention is to provide a printing device, a printing system, and a control method of a printing device that can easily adjust how a barcode is printed.

One aspect of at least one embodiment of the present invention is a printing device including: a reception unit that receives a command; an interpreter unit that interprets commands received by the reception unit; a print unit that prints a barcode; a first storage unit that stores a first adjustment value adjusting how the print unit prints the barcode; an acquisition unit that acquires a second adjustment value when a command interpreted by the interpreter unit is a command specifying the second adjustment value; and a print control unit that prints a barcode by the print unit based on the first adjustment value stored in the first storage unit and the second adjustment value acquired by the acquisition unit when the command interpreted by the interpreter unit is a command instructing printing a barcode.

Thus comprised, by sending a command to the printer, barcodes can be printed to reflect a first adjustment value previously stored in the printer and a second adjustment value specified by a command. As a result, barcodes can be printed in the desired format by simply specifying an additional (second) adjustment value by sending a command even when printing the barcode must be adjusted using an additional adjustment value (second adjustment value) in addition to a constant (first adjustment value). Therefore, how a barcode is printed can be easily adjusted, and barcodes can be desirably printed whether or not the constant stored in the printer is suitable for the particular print medium.

Preferably, the printing device also has a receive buffer that accumulates commands received by the reception unit. The interpreter unit sequentially interprets commands accumulated in the receive buffer, and when a command instructing printing a barcode and a command specifying the second adjustment value are stored in the receive buffer, causes the acquisition unit to acquire the second adjustment value, and the print control unit to print the barcode based on the second adjustment value.

Thus comprised, when a command specifying an additional adjustment value and a command instructing printing a barcode are sent to a printer, the printer prints the barcode in a way reflecting the additional adjustment value specified by the command. As a result, there is no need to send a command specifying the additional adjustment value before sending a command instructing printing the barcode. The operation for declaring an additional adjustment value is therefore further simplified.

In another aspect of at least one embodiment of the present invention, the printing device also has a second storage unit that stores the second adjustment value acquired by the acquisition unit; the print control unit printing the barcode by the print unit based on the first adjustment value stored in the first storage unit and the second adjustment value stored in the second storage unit when a command interpreted by the interpreter unit is a command instructing printing a barcode.

Thus comprised, when the printer is instructed to set an additional adjustment value using a command, the printer stores the additional adjustment value and prints the barcode to based on the additional adjustment value. As a result, when there is no need to change the additional adjustment value, barcodes can still be printed to reflect the additional adjustment value by simply sending a print command, and barcode printing is further simplified.

In another aspect of at least one embodiment of the present invention, the first storage unit stores the first adjustment value relationally to a type of print medium; the acquisition unit acquires and stores the second adjustment value in the second storage unit relationally to the specified type of print medium when a command interpreted by the interpreter unit is a command specifying a type of print medium and the second adjustment value; and the print control unit reads the first adjustment value and second adjustment value related to the type of print medium printed by the print unit from the first storage unit and the second storage unit, and prints a barcode based on the first adjustment value and second adjustment value that were read.

Thus comprised, by storing constant related to types of print media in the printer and specifying the type of print medium and additional adjustment value by commands, the additional adjustment values can be relationally stored to the types of print media. As a result, if the type of print medium is specified for the printer when instructing the printer to print, barcodes can be desirably printed based on the constant and additional adjustment value appropriate to the type of print medium.

Further preferably, the command specifying the second adjustment value is a command having a parameter that declares the second adjustment value within a predefined numeric range.

Thus comprised, the second adjustment value can be declared by a number.

In another aspect of at least one embodiment of the present invention, the first adjustment value stored in the first storage unit, and the second adjustment value specified by a command, are values indicating a correction amount for the width of bars in the barcode printed by the print unit.

Thus comprised, the width of the bars can be adjusted when printing a barcode based on a constant and an additional adjustment value, and the barcode can be desirably printed.

Another aspect of at least one embodiment of the present invention is a printing system including a printing device and a communicatively connected print control device. The print control device sends commands to the printing device. The printing device includes a reception unit that receives commands sent from the print control device; an interpreter unit that interprets commands received by the reception unit; a print unit that prints a barcode; a first storage unit that stores a first adjustment value adjusting how the print unit prints the barcode; an acquisition unit that acquires a second (additional)) adjustment value when a command interpreted by the interpreter unit is a command specifying the second adjustment value; and a print control unit that prints a barcode by the print unit based on the first adjustment value stored in the first storage unit and the second adjustment value acquired by the acquisition unit when the command interpreted by the interpreter unit is a command instructing printing a barcode.

Thus comprised, by sending a command from the print control device to the printer, barcodes can be printed to desirably reflect a constant stored by the printer and an additional adjustment value specified by a command. As a result, even when an additional adjustment value is needed in addition to the constant, barcodes can be desirably printed by only specifying the additional adjustment value by a command. Therefore, how a barcode is printed can be easily adjusted, and barcodes can be desirably printed whether or not the constant stored in the printer is suitable for the particular print medium.

A control method of a printing device according to another aspect of at least one embodiment of the present invention also includes: storing a first adjustment value adjusting how the print unit prints the barcode; receiving a command; interpreting the received command; acquiring a specified second adjustment value when the interpreted command is a command specifying a second adjustment value adjusting how to print the barcode; and printing a barcode based on the previously stored first adjustment value and the second adjustment value acquired from a command when the interpreted command is a command instructing printing a barcode.

Thus comprised, by sending a command to the printer, barcodes can be printed to desirably reflect a constant stored by the printer and an additional adjustment value specified by a command. As a result, even when an additional adjustment value is needed in addition to the constant, barcodes can be desirably printed by only specifying the additional adjustment value by a command. Therefore, how a barcode is printed can be easily adjusted, and barcodes can be desirably printed whether or not the constant stored in the printer is suitable for the particular print medium.

### BRIEF DESCRIPTION OF THE DRAWINGS

FIG. 1 is a function block diagram of a printing system according to some embodiments of the invention.

FIG. 2 is a flow chart showing the operation of a printing system according to a first embodiment of the invention.

FIG. 3 is a flow chart showing the operation of a printing system according to a first embodiment of the invention.

FIG. 4A shows an example of a user correction values stored in the printer storage unit in a second embodiment of the invention.

FIG. 4B shows another example of a user correction values stored in the printer storage unit in a second embodiment of the invention.

FIG. 5 is a flow chart showing the operation of a printing system according to a second embodiment of the invention.

FIG. 6 is a flow chart showing the operation of a printing system according to a second embodiment of the invention.

### DESCRIPTION OF EMBODIMENTS

### Embodiment 1

At least one embodiment of the present invention is described below with reference to the accompanying figures.

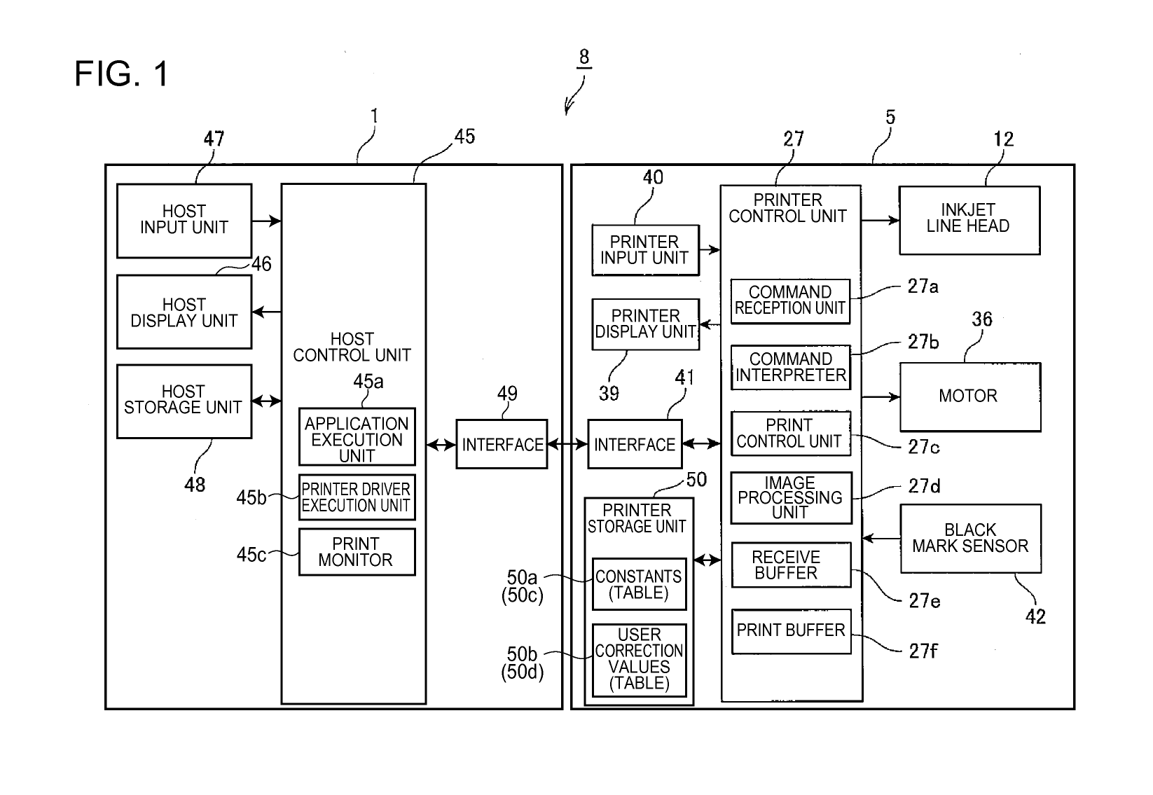

FIG. 1 is a function block diagram of a printing system 8 according to this embodiment of the present invention.

The printing system 8 includes a printer 5 (printing device), and a host computer 1 (printing control device) that controls the printer 5.

The printing system 8 is a printing system in which the host computer 1 outputs print commands and print data to the printer 5 in response to user operations, and the printer 5 prints on print media based on the print commands and print data.

The host computer 1 has a host control unit 45 that controls other parts of the host computer 1. The host control unit 45 has an application execution unit 45a, a printer driver execution unit 45b, and a print monitor 45c.

The application execution unit 45a executes applications (programs) such as a text editing program, image editing program, POS application, or label editing program. When printing is commanded by a user operation, the application execution unit 45a generates and outputs print data for printing the created document or image.

The printer driver execution unit 45b executes a device driver (program) for controlling the printer 5. The printer driver execution unit 45b controls printer 5 operation by generating and outputting commands to control the printer 5 and data related to those commands. For example, the printer driver execution unit 45b generates and outputs print data and print commands instructing the printer 5 to print based on the data output by the application execution unit 45a. Note that the device driver run by the printer driver execution unit 45b is not limited to a program optimized for the printer 5, and could be a generic device driver. The device driver could also be a device driver for a different model of printer. In this event, the printer 5 is configured to process commands and data output by the printer driver execution unit 45b for the different model of printer.

The print monitor 45c runs a monitoring program for monitoring the printer 5. The print monitor 45c detects the operating status of the printer 5, and controls monitoring transmission of commands generated by the printer driver execution unit 45b and responding to commands sent to the printer 5.

More specifically, the print monitor 45c sequentially acquires the commands output by the printer driver execution unit 45b, and sends the commands to the printer 5. When sending plural commands to the printer 5, the print monitor 45c adjusts the transmission sequence and the transmission timing so that the printer 5 executes the commands in a specific order. In this event, the print monitor 45c may, for example, send a command to the printer 5, and delay sending the next command until after a response to the first command is received.

When the application execution unit 45a outputs a command, the print monitor 45c acquires the command and controls transmission in the same way as transmission of commands output by the printer driver execution unit 45b.

When the print monitor 45c sends a command generated by the application execution unit 45a or printer driver execution unit 45b to the printer 5 and then receives a response from the printer 5, it returns the received response to the unit that generated the original command. The application execution unit 45a and printer driver execution unit 45b can therefore receive the response to the generated command.

The print monitor 45c generally executes a language monitor (LM) or port monitor to apply the above control. The print monitor 45c may be a module that is part of the host computer 1 operating system or the printer driver execution unit 45b.

The host computer 1 also has a host display unit 46 for displaying information, a host input unit 47 for detecting operation of the connected input devices, a host storage unit 48 for storing data, and a communication interface 49 for communicating with the printer 5. The host display unit 46 and host input unit 47 are provided for user operation. The host storage unit 48 nonvolatilely stores programs such as the control program, application program, or device driver run by the host control unit 45, and data related to these programs.

In the example described in this embodiment of the present invention, the host computer 1 outputs print commands and print data for printing labels containing a barcode. In this event, the application execution unit 45a instructs printing an image including a barcode, and the printer driver execution unit 45b generates print data including the barcode and print commands for printing. The barcode data generated by the application execution unit 45a may, for example, conform to a known standard such as JAN code, EAN, UPC code, ITF code, CODE39, CODE128, or NW-7, or to a proprietary code. These barcodes are printed using a barcode font. The printer driver execution unit 45b therefore outputs barcode print data including data specifying the barcode font and the character codes to be printed.

The host computer 1 may send a command specifying the barcode printing format. This embodiment describes an example of specifying a parameter for adjusting the width of bars in the barcode by a function of the printer driver execution unit 45b. This command is described in detail below.

One example of the printer 5 according to this embodiment is an inkjet printer. In this embodiment the printer 5 has an inkjet line head 12 (print unit) with nozzles that eject ink. The inkjet line head 12 is a line head with nozzles arranged in rows across the entire print area in the direction perpendicular to the conveyance direction of the print medium. The inkjet line head 12 in this embodiment has a separate nozzle row for each of four colors, cyan (C), magenta (M), yellow (Y), and black (K), and is capable of full-color printing on the print medium. The inkjet line head 12 may obviously be configured to use more colors of ink, or be configured to print with two colors or one color for monochrome printing.

The print media used by the printer 5 may be cut-sheet media that is precut to a specific size, or continuous sheet media, and the sheet media may be paper or plastic media, with or without a coated surface. The continuous sheet media may be roll paper or fanfold paper, for example.

The print medium in the printer 5 according to this embodiment is roll paper or label paper having labels of a specific size with an adhesive coating on the back affixed to a removable liner (backing).

Many different types of roll paper or label paper may be used in the printer 5. Examples of such print media include plain paper, fanfold paper, plain paper labels, fine paper labels, plastic label paper, and glossy label paper. The printing surface of plain paper and plain paper labels is plain paper. Fine paper and fine paper labels are made of fine paper with excellent ink absorbency and fastness characteristics. Plastic label paper is label paper made with a plastic sheet. Glossy label paper is label paper made with glossy paper that offers excellent ink absorbency, fastness, and chromogenicity, and retains its glossy finish after absorbing ink.

The printer 5 has a printer control unit 27 (print control unit, acquisition unit) that controls other parts of the printer 5. The printer control unit 27 includes a CPU as an operating unit, ROM and RAM. Firmware that can be executed by the CPU and data related to the firmware is nonvolatilely in the ROM of the printer control unit 27. Data related to the firmware run by the CPU is also temporarily stored in RAM. The printer control unit 27 may also have other peripheral circuits.

In addition to the inkjet line head 12 described above, a motor 36, printer display unit 39, printer input unit 40, communication interface 41, black mark sensor 42, and printer storage unit 50 are also connected to the printer control unit 27.

The printer display unit 39 has LEDs or an LCD panel and displays the operating status of the printer 5 as controlled by the printer control unit 27, for example.

The printer input unit 40 includes various switches, and outputs signals corresponding to the operation of the switches to the printer control unit 27.

The communication interface 41 is connected to the host computer 1. The communication interface 41 (interface) communicates with the host computer 1 according to a specific protocol as controlled by the printer control unit 27.

The black mark sensor 42 is an optical sensor disposed to the conveyance path through which the print medium (label paper or roll paper) is conveyed inside the printer 5, and detects the black marks (not shown in the figure) formed on the print medium for positioning.

The motor 36 turns the conveyance rollers (not shown in the figure) as controlled by the printer control unit 27 to convey the label paper 14. The motor 36 is a stepper motor, for example, and the amount and direction of rotation of the motor 36 can be controlled by the printer control unit 27. The motor 36 can be included with the inkjet line head 12 in the print unit.

The black mark sensor 42 detects the black marks while the label paper 14 is being conveyed, and outputs the sensor values to the printer control unit 27.

The printer control unit 27 includes a command reception unit 27a (reception unit), a command interpreter 27b (interpreter unit), a print control unit 27c, and an image processing unit 27d (acquisition unit) as execution units for executing functions. These execution units are functions rendered by the CPU running firmware. A receive buffer 27e and a print buffer 27f are reserved in the storage area in the RAM (not shown in the figure) of the printer control unit 27.

Alternatively, either or both the receive buffer 27e and print buffer 27f could be provided in the printer storage unit 50, or in RAM externally connected to the printer control unit 27.

The printer storage unit 50 (first storage unit, second storage unit) has a storage medium such as EEPROM, flash memory, or other type of semiconductor memory, or a hard disk drive, and nonvolatilely stores data rewritably. The printer storage unit 50 stores programs that are executed by the printer control unit 27, and data including font data that is processed by the printer control unit 27.

The command reception unit 27a receives and stores commands and data sent from the host computer 1 through the interface 41 in the receive buffer 27e. The commands and data the command reception unit 27a receives are accumulated in the receive buffer 27e in the order received.

The command interpreter 27b reads and interprets the commands and data stored in the receive buffer 27e sequentially according to the address in the receive buffer 27e. Because the commands and data are accumulated in the receive buffer 27e in the order received, the commands and data are interpreted by the command interpreter 27b in the order received. If the interpreted command or data is a command to be executed by the print control unit 27c or data to be processed by the print control unit 27c, the command interpreter 27b passes the command or data to the print control unit 27c. If the interpreted command or data is a command to be executed by the image processing unit 27d or data to be processed by the image processing unit 27d, the command interpreter 27b passes the command or data to the image processing unit 27d.

The print control unit 27c executes the commands and processes the data passed from the command interpreter 27b. More specifically, the print control unit 27c executes a printing operation according to the print commands, and prints text and images based on the print data. In the printing operation, the print control unit 27c controls the motor 36 to convey the label paper 14, and drives the inkjet line head 12 to eject ink.

The print control unit 27c calls the image processing unit 27d to process the print data input from the host computer 1. The image processing unit 27d renders the print data in the print buffer 27f as rasterized image data.

The print buffer 27f is a storage area created according to the print resolution of the inkjet line head 12 and the size of the printable area of the printer 5.

The image processing unit 27d executes the commands and processes the data passed from the command interpreter 27b. For example, if the command passed from the command interpreter 27b includes a parameter for a setting related to image processing, it reads the parameter and sets or changes the setting accordingly.

Print data including data specifying the barcode font and character codes is output from the host computer 1 in this embodiment. The image processing unit 27d reads the font data stored in the printer storage unit 50, and writes barcode image data to the print buffer 27f.

The print control unit 27c prints the image rendered in the print buffer 27f by the inkjet line head 12. The image data rendered in the print buffer 27f is rasterized image data setting print color data for each pixel in a specific number of pixels (specific dot count) covering the printable area of the printer 5. Based on a predefined lookup table (LUT), the print control unit 27c converts the color information for each pixel in the image data rendered in the print buffer 27f to the amount of each color of ink to be ejected by the inkjet line head 12 for each pixel. The print control unit 27c then determines the position and size of each color of ink dot formed by the inkjet line head 12 ejecting ink droplets based on the converted ink volume data, and prints.

The image processing unit 27d also has a function for adjusting the barcode image data rendered in the print buffer 27f.

As described above, the print medium used by the printer 5 could be plain paper, fine paper, plain paper labels, fine paper labels, plastic labels, or glossy labels, for example. The surface characteristics of the printing surfaces of these media differ, particularly the occurrence of ink bleeding. For example, fine paper has excellent ink absorbency and is therefore resistant to bleeding, but plain paper and plastic labels do not have good ink absorption and ink bleeds easily. Significant bleeding can therefore occur depending on the type of print medium when image data for a barcode rendered in the print buffer 27f is printed. This bleeding can increase the width of the black parts (bars) of the barcode, and the printed barcode will be a barcode that does not conform to the barcode standard if the bar width exceeds the standard width, or the white part (space) between bars narrows as a result of the bar width increasing. As a result, the barcode reader may not be able to read the resulting barcode normally.

There may also be differences in the characteristics of individual inkjet line heads 12, and small differences in the size can occur in some of the bars printed on the print medium. Because of small differences in bar width in this event, the bar width may exceed the standard if a print medium is used that results in easy bleeding.

The image processing unit 27d of the printer 5 therefore adjusts the image of the barcode rendered in the print buffer 27f. More specifically, the image processing unit 27d adjusts the width of the bars in the barcode based on a constant 50a (first adjustment value) and a user correction value 50b (second adjustment value) stored in the printer storage unit 50 to desirably print a barcode that does not deviate from the standard.

The constants 50a are stored in the printer storage unit 50 when firmware is written before the printer 5 is shipped from the factory or when the firmware is updated. If the types of print media that the printer 5 can use for printing are particularly limited, the constants 50a are values used to print desirably according to the type of print medium. The constants 50a may also be set to eliminate individual differences resulting from the characteristics of the inkjet line head 12 used in the printer 5 and reliably print barcodes conforming to the particular barcode standard.

The user correction values 50b are values that further adjust the barcode bar widths after being adjusted according to the constant 50a. The user correction values 50b can be set by sending a command from the host computer 1 to the printer 5. For example, the user may set the user correction value 50b to adjust the bar width according to the type of print media used in the printer 5.

The constant 50a and user correction value 50b are, for example, correction amounts for making the bar width smaller (narrower) or larger (thicker) in dot units. In this example, when the correction value is −2, the image processing unit 27d adjusts the bar width in the barcode image rendered in the print buffer 27f to be 2 dots narrower. A positive correction value makes the bar width thicker, and a negative correction value makes the bar width narrower.

When both constants 50a and user correction values 50b are stored in the printer storage unit 50, the image processing unit 27d adjusts the bar width to get a printout reflecting both the constant 50a and user correction value 50b. For example, if the constant 50a is −2 and the user correction value 50b is −1, the image processing unit 27d uses the sum (−3) of −2 and −1 as the correction value, and narrows the bar width by 3 dots.

A command for setting the user correction value 50b is described in detail next.

The command used in the printing system 8 according to this embodiment includes a prefix character, command identifier, and parameter.

The prefix character is, for example, a single-character ASCII code that identifies the type of command. The printing system 8 uses two types of commands, formatting commands and control commands. A formatting command is a command instructing the print format for printing by the printer 5, and a printing operation. A control command is a command related to controlling the printer 5. The prefix character of a formatting command is a single-byte forward slash character (/), and the prefix character of a control command is a single-byte asterisk (*).

The command identifier indicates the type of command, and is a 1 to 3 character ASCII code, for example. The parameter is a value controlling a function of the command, and declares the value by an ASCII code of one or more characters. The parameter may use numbers, may use letters, or may use both numbers and letters depending upon the type of command. Numeric parameters have maximum and minimum limits corresponding to the type of command. If the parameter value exceeds the maximum limit, the command interpreter 27b uses the maximum as the declared value. If the parameter value is less than the minimum limit, the command interpreter 27b uses the minimum as the declared value. If the parameter is omitted, the command interpreter 27b uses a default value as the declared value.

Commands for setting a user correction value 50b in the printing system 8 are defined by both formatting commands and control commands. An example of the formatting command is shown in (1) below, and an example of a control command is shown in (2) below.

/FDCX(parameter) (1)

*HDCX(parameter) (2)

The parameter is the user correction value 50b, and in this example is a number from +3 to −3.

The formatting command has a predefined syntax, and includes a group of commands starting with a start label format code and ending with an end label format code. Plural commands including a prefix character, command identifier, and parameter are written between the start code and the end code. The host computer 1 can send plural commands to the printer 5 using this syntax.

For example, if a command declaring the beginning of the barcode printing area (field), a command specifying the barcode, and a command specifying the end of the printing area are included, the printer 5 interprets the command and prints a barcode. A command declaring the user correction value 50b (/FDCX(parameter)) can also be written between the start code and end code. In this event, the command interpreter 27b stores the user correction value 50b declared in the command in the printer storage unit 50, and the print control unit 27c uses this user correction value 50b to print the barcode.

If a formatting command is received, the command reception unit 27a receives and stores the commands in the command group between the start code and the end code to the receive buffer 27e in the order of the commands in the group. As a result, the commands written between the start code and the end code are interpreted by the command interpreter 27b in the order they appear in the command group.

The order of the formatting commands in the command group between the start label format code and end label format code is not specifically limited, but the commands are preferably arranged in an execution sequence suited to the commands. For example, if the command group includes commands related to print instructions and commands related to the printing format, the order of the commands in the group will determine whether or not the content of the settings of the commands setting the printing format will be reflected when printing. The formatting commands are accumulated in the receive buffer 27e in the order they appear in the command group, and are interpreted and executed by the command interpreter 27b in the order they are accumulated.

For example, if the commands setting the printing format are listed first, and the commands instructing printing are listed after the formatting commands, the printer 5 will print after setting the printing format. More specifically, the format will be set by the commands contained in one command group, and printing will then follow according to the settings.

However, if the commands related to the print instructions are listed first, the format will be set after printing is completed. In this event, printing will not reflect the format settings.

When the printer driver execution unit 45b and print monitor 45c generate a group of commands including commands related to print instructions and commands setting the printing format, the commands are arranged according to a predetermined command sequence. In this embodiment of the present invention, commands setting the printing format are listed first, and are followed by commands related to print instructions.

The control commands do not have a defined syntax, and commands are sent individually from the host computer 1 to the printer 5. To specify a user correction value 50b, the command *HDCX (parameter) is sent individually from the host computer 1 to the printer 5. In this event, the command reception unit 27a stores one command in the receive buffer 27e, and the command interpreter 27b interprets and executes the one command.

When the command interpreter 27b detects a *HDCX (parameter) command, it stores the parameter in this command as the user correction value 50b in the printer storage unit 50. This user correction value 50b is referenced by the image processing unit 27d to adjust the bar width of the barcode until the user correction value 50b is updated by a parameter received later.

By using formatting commands in this printing system 8, user correction value 50b can be specified together with commands instructing printing. User correction values 50b can also be set at the desired timing by control commands without restricting the timing for printing.

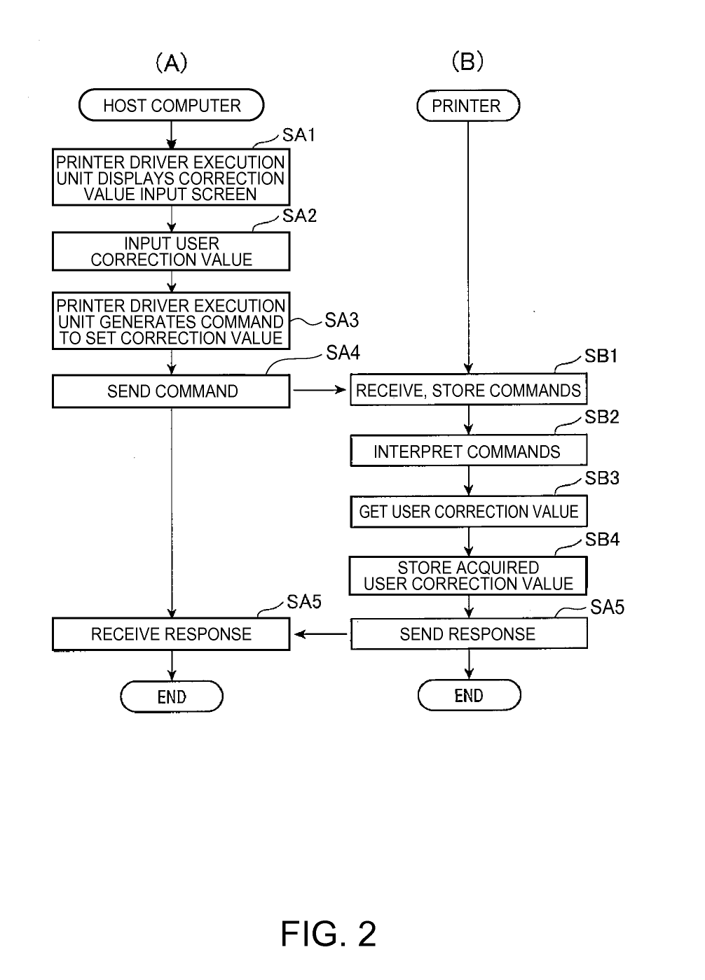

FIG. 2 is a flow chart of the operation of the printing system 8 related to setting user correction values, (A) showing the operation of the host computer 1, and (B) showing the operation of the printer 5.

The host computer 1 displays a screen for inputting user correction values by a function of the printer driver execution unit 45b in response to operation of an input device connected to the host input unit 47 (step SA1). A user correction value is then input by an operation interacting with the displayed screen (step SA2). The printer driver execution unit 45b generates and outputs a command for setting the input user correction value (step SA3). More specifically, the printer driver execution unit 45b provides a user interface for inputting a user correction value 50b, and outputs the value input using this user interface. Because only a user correction value 50b is set by the operation shown in FIG. 2, the printer driver execution unit 45b generates a control command that sets the user correction value 50b. The print monitor 45c of the host computer 1 sends the command output by the printer driver execution unit 45b to the printer 5 (step SA4).

The command reception unit 27a receives and stores the command the host computer 1 sent in the receive buffer 27e (step SB1). Next, the command interpreter 27b interprets the commands in the receive buffer 27e (step SB2), and if the command is determined to be a command setting a user correction value 50b, passes the command to the image processing unit 27d. The image processing unit 27d acquires and stores the user correction value 50b set by the command (step SB3) in the printer storage unit 50 (step SB4). If a user correction value 50b is already stored in the printer storage unit 50, the image processing unit 27d overwrites the user correction value 50b with the new value. As a result, the new user correction value 50b is set in the printer storage unit 50.

After setting the user correction value 50b, the printer control unit 27 sends a response command indicating that the process instructed by the command ended to the host computer 1 (step SB5). The print monitor 45c then receives the response sent from the printer 5 (step SA5). This response command is a response to the set command generated by the printer driver execution unit 45b. The print monitor 45c thus recognizes the response to the command from the printer driver execution unit 45b, and may report to the printer driver execution unit 45b that the setting was successfully completed.

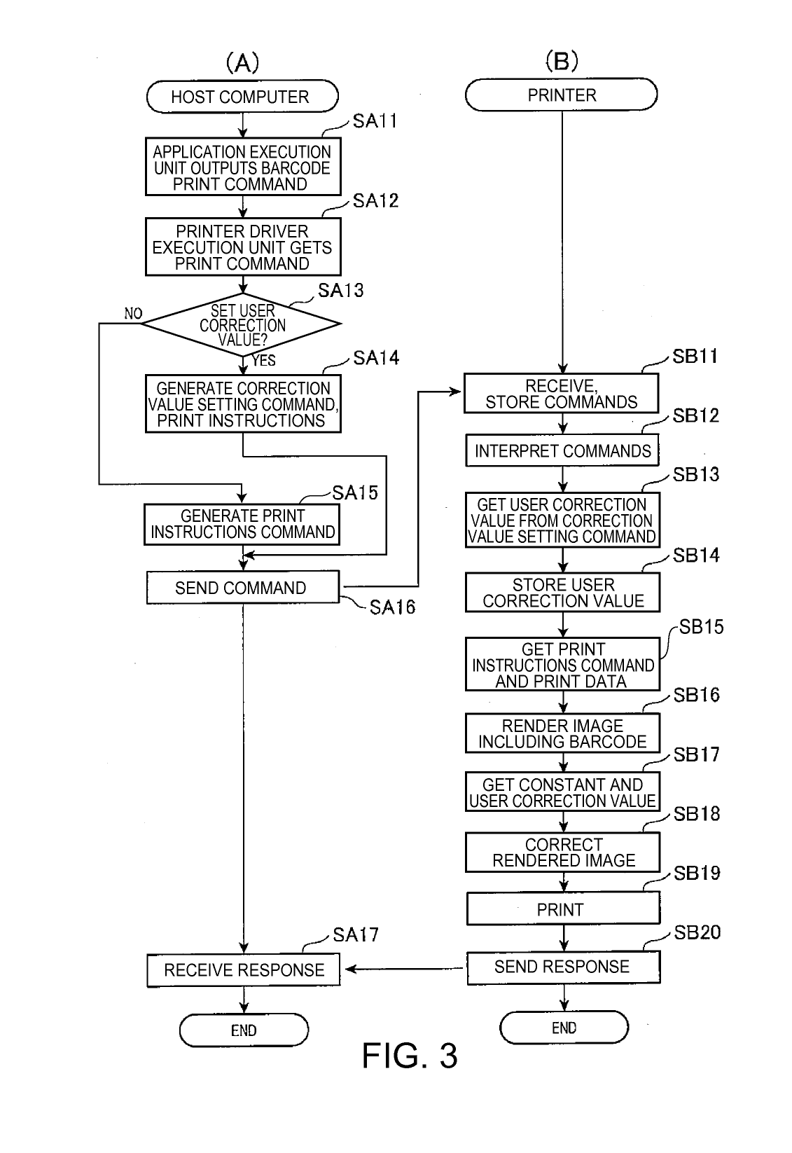

FIG. 3 is a flow chart of the operation of the printing system 8 related to setting user correction values, (A) showing the operation of the host computer 1, and (B) showing the operation of the printer 5. Note that the operation shown in FIG. 3 can obviously be executed consecutively to the operation shown in FIG. 2.

In this example, the application execution unit 45a outputs data and a print command for printing an image including a barcode to the printer driver execution unit 45b (step SA11). The printer driver execution unit 45b then acquires the data and print command input from the application execution unit 45a (step SA12). The printer driver execution unit 45b then determines if setting a user correction value 50b is commanded together with printing (step SA13). For example, a user interface of the printer driver execution unit 45b could be displayed when printing is instructed by the host computer 1. If this user interface has an input field for a user correction value and a button for issuing a print command, both the print command and a command for setting a user correction value 50b could be issued together.

To set a user correction value 50b when printing (step SA13: Yes), the printer driver execution unit 45b generates a formatting command including a command to set the user correction value 50b and a command related to printing instructions (step SA14). The plural commands generated here are an example of the command group described above.

However, if a user correction value 50b is not set (step SA13: No), the printer driver execution unit 45b generates only a command related to printing instructions (step SA15). The command related to printing instructions is a formatting command including, for example, a command specifying where to start printing the barcode described above, a command specifying the barcode, and a command specifying the end of the print area.

The printer driver execution unit 45b outputs the commands generated in steps SA14 and SA15 to the print monitor 45c, and the print monitor 45c sends the commands to the printer 5 (step SA16).

The command reception unit 27a receives and stores the commands the host computer 1 sent in the receive buffer 27e (step SB11). If the commands sent by the host computer 1 are a command group including plural formatting commands, the command reception unit 27a sequentially stores the plural commands in the command group in the receive buffer 27e. The command interpreter 27b then sequentially interprets the commands in the receive buffer 27e (step SB12), and if there is a command to set a user correction value 50b, passes the command to the image processing unit 27d. The image processing unit 27d then gets and stores the user correction value 50b specified by the command (step SB13) in the printer storage unit 50 (step SB14). Note that if there is not a command in the receive buffer 27e to set a user correction value 50b, steps SB13 and SB14 are skipped.

When there is a command related to a printing instruction in the receive buffer 27e, the command interpreter 27b passes the command to the print control unit 27c. The print control unit 27c gets the commands related to printing instructions and the data for the barcode to print (step SB15). Next, the image processing unit 27d gets the barcode font based on the acquired commands and print data, and renders image data including the barcode in the print buffer 27f (step SB16).

The image processing unit 27d gets the constant 50a and user correction value 50b stored in the printer storage unit 50 (step SB17). The image processing unit 27d then corrects the image of the barcode rendered in the print buffer 27f based on the constant and user correction value (step SB18).

The print control unit 27c converts the image data rendered in the print buffer 27f to ink volume data for the inkjet line head 12 based on the LUT, and drives the inkjet line head 12 and motor 36 to print (step SB19).

After printing is completed, the printer control unit 27 sends a response command indicating that printing ended to the host computer 1 (step SB20). The print monitor 45c receives the response command sent from the printer 5 (step SA17). This response command is a response to the settings command generated by the application execution unit 45a, or by the application execution unit 45a and the printer driver execution unit 45b. The print monitor 45c may also report to the application execution unit 45a and/or the printer driver execution unit 45b that the setting was completed.

As described above, a printer 5 according to this embodiment has an inkjet line head 12 that prints a barcode, and a printer storage unit 50 that stores constants for adjusting how the barcode is printed by the inkjet line head 12. The printer 5 also has a printer control unit 27, and the printer control unit 27 has a command reception unit 27a, a command interpreter 27b, a print control unit 27c, and an image processing unit 27d. The command reception unit 27a receives commands, and the command interpreter 27b interprets the commands received by the command reception unit 27a.

The image processing unit 27d acquires and sets the specified user correction value 50b when the command interpreted by the command interpreter 27b is a command specifying a user correction value 50b.

When the command interpreted by the command interpreter 27b is a command instructing printing a barcode, the print control unit 27c controls printing the barcode in a manner reflecting the constant 50a and user correction value 50b.

As a result, barcode can be printed in the desired manner reflecting the constant 50a and user correction value 50b by sending a command to the printer 5. How a barcode is printed can therefore be easily adjusted, and barcodes can be printed desirably according to the barcode standard whether or not the constant 50a stored in the printer 5 is appropriate to the print medium actually used for printing.

The printer 5 also has a receive buffer 27e that accumulates commands received by the command reception unit 27a. The command interpreter 27b sequentially interprets the commands in the receive buffer 27e. When a command related to printing a barcode and a command specifying a user correct ion value 50b are stored, the image processing unit 27d is controlled to acquire the user correction value 50b, and the print control unit 27c controls printing a barcode to reflect the user correction value 50b. As a result, a user correction value 50b can be set when instructing printing a barcode, and there is no need to send a command setting the user correction value 50b in advance of printing a barcode. The task of specifying a user correction value 50b is therefore simplified.

The printer 5 stores the user correction value 50b acquired by the print control unit 27c in the printer storage unit 50. The print control unit 27c prints a barcode reflecting the constant 50a and user correction value 50b stored in the printer storage unit 50 by the inkjet line head 12. As a result, when there is no need to change the user correction value 50b, printing can still reflect the user correction value 50b by simply instructing printing, and barcode printing can be simplified.

Furthermore, because the command setting a user correction value 50b is a command including a parameter setting the user correction value 50b within a predetermined numeric range of values, the user correction value 50b can be set by declaring a number.

Furthermore, the constant 50a and user correction value 50b in the printer 5 are values indicating the correction of the width of the bars in the barcode to be printed by the inkjet line head 12. In this event, the bar width can be adjusted using the constant 50a and user correction value 50b when printing a barcode, and a barcode can be printed desirably according to the barcode standard.

### Embodiment 2

A second embodiment of the present invention is described next.

The configuration of the printing system 8 according to the second embodiment of the present invention is the same as the printing system 8 of the first embodiment shown in FIG. 1, and another function block diagram is therefore omitted.

A constants table 50c and a user correction values table 50d are stored as lookup tables in the printer storage unit 50 in this second embodiment of the present invention.

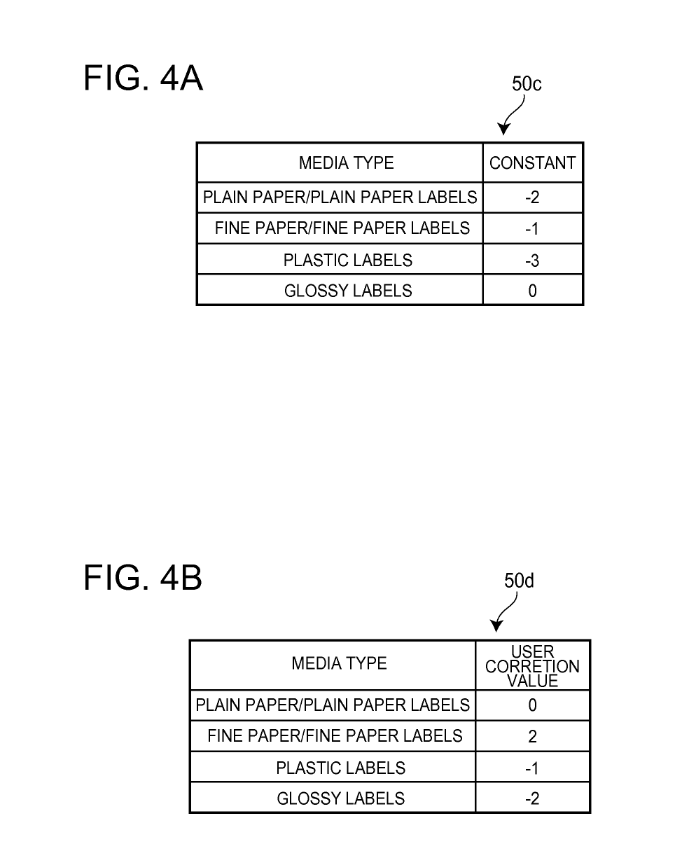

FIG. 4A and FIG. 4B show exemplary tables of constants and user correction values stored in the printer storage unit 50, respectively. FIG. 4A shows an example of a constants table 50a, and FIG. 4B shows an example of a user correction values table 50b.

As described above, many different types of roll paper or label paper may be used as the print medium in the printer 5. Examples of such print media include plain paper, fanfold paper, plain paper labels, fine paper labels, plastic label paper, and glossy label paper. The constants table 50c is a table of constants set for specific types of print media. The user correction values table 50d is a table of user correction values set by the user for the specific types of print media.

The constants table 50c is stored in the printer storage unit 50 when firmware is written before the printer 5 is shipped from the factory or when the firmware is updated.

The types of media for which constants are set in the constants table 50a correspond to the types of print media that can be used in the printer 5. A subset of constants corresponding to some of the most typical print media could also be stored instead of storing constants for all print media that can be used.

The host computer 1 can set the types of print media using a device driver run by the printer driver execution unit 45b. The print media type settings in the printer driver execution unit 45b, and the media types for which constants are set in the constants table 50c, preferably match. Four types of print media, plain paper and plain paper labels, fine paper and fine paper labels, plastic labels, and glossy labels, are set in this embodiment, and constants are stored for each of these types.

The user correction values table 50d is input through a user interface displayed by the printer driver execution unit 45b on the host computer 1. The user interface provided by the printer driver execution unit 45b has input fields and selection buttons, for example, for inputting the print media types and user correction value for each print medium.

The constants set in the constants table 50c, and the user correction values set in the user correction values table 50d, are values that increase or decrease the bar widths of the barcode in dot units. These values are the same as the constants 50a and user correction values 50b described above.

When printing is instructed by the print control unit 27c, the image processing unit 27d corrects the image of the barcode rendered in the print buffer 27f based on the constants set in the constants table 50c and the user correction values set in the user correction values table 50d. To do this, the image processing unit 27d determines the type of print medium used for printing, and gets the constant and the user correct ion value for that type of print medium from the constants table 50c and user correction values table 50d. The image processing unit 27d then corrects the barcode image based on the sum of the constant and user correction value. As a result, how the barcode is printed can be adjusted based on the characteristics of the particular type of print medium, and the constants and user correction values previously stored in the printer storage unit 50.

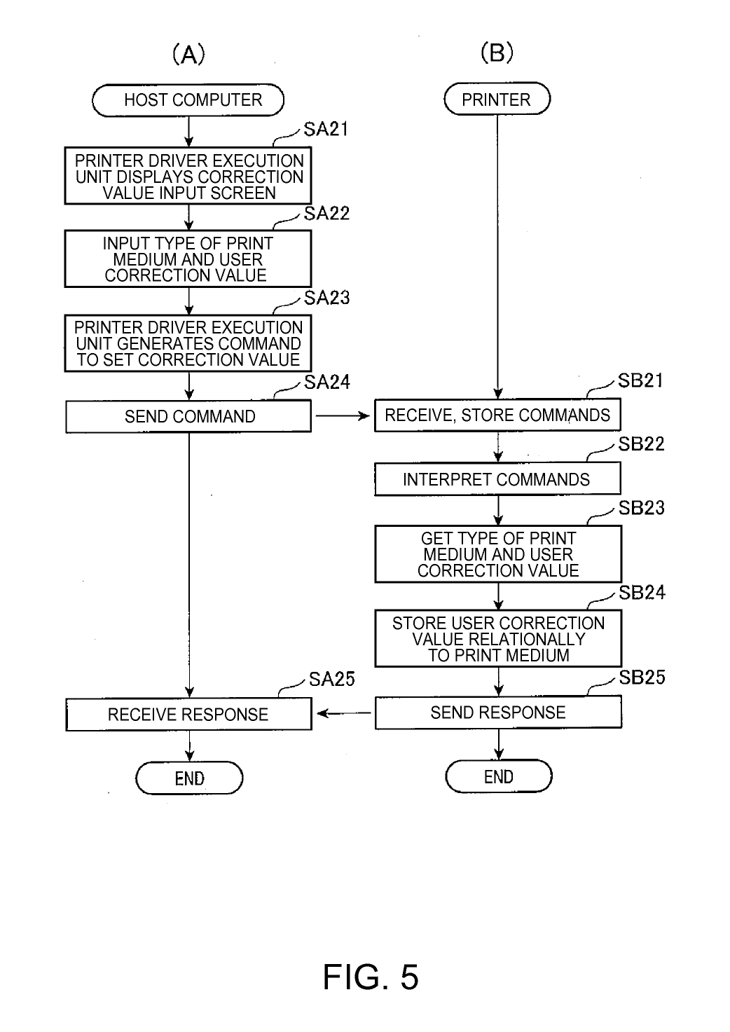

FIG. 5 is a flow chart of the operation of the printing system 8 related to setting user correction values, (A) showing the operation of the host computer 1, and (B) showing the operation of the printer 5.

The host computer 1 displays a screen for inputting user correction values by a function of the printer driver execution unit 45b in response to operation of an input device connected to the host input unit 47 (step SA21). As described above, the type of print medium, and the user correction value corresponding to the selected print media type, are input by an operation interacting with the displayed screen (step SA22). The printer driver execution unit 45b generates and outputs a command setting the input print media type and the input user correction value (step SA23). The print monitor 45c of the host computer 1 sends the command output by the printer driver execution unit 45b to the printer 5 (step SA24).

The command reception unit 27a receives and stores the command the host computer 1 sent in the receive buffer 27e (step SB21). Next, the command interpreter 27b interprets the commands in the receive buffer 27e (step SB22), and if the command is determined to be a command setting a user correction value 50b, passes the command to the image processing unit 27d. The image processing unit 27d acquires and stores the print media type and the user correction value 50b set by the command (step SB23). The image processing unit 27d stores the acquired user correction value relationally to the type of print medium in the user correction values table 50d stored in the printer storage unit 50 (step SB24). If a user correction value 50b is already set in the printer storage unit 50, the image processing unit 27d overwrites the user correction value 50b with the new value.

The printer control unit 27 then sends a response command indicating that the process instructed by the command ended to the host computer 1 (step SB25). The print monitor 45c then receives the response command sent from the printer 5 (step SA25). This response command is a response to the set command generated by the printer driver execution unit 45b. The print monitor 45c thus recognizes the response to the command from the printer driver execution unit 45b, and may report to the printer driver execution unit 45b that the setting was successfully completed.

Note that because the type of print medium used can be preset, the printer 5 can set the acquired user correction value in the user correction values table 50d as the user correction value for the type of print medium being used without the host computer 1 sending a command declaring the type of print medium. In this event there is no need to declare the type of print medium in step SA22, and the parameters of the command generated in step SA23 do not include a parameter declaring the type of print medium.

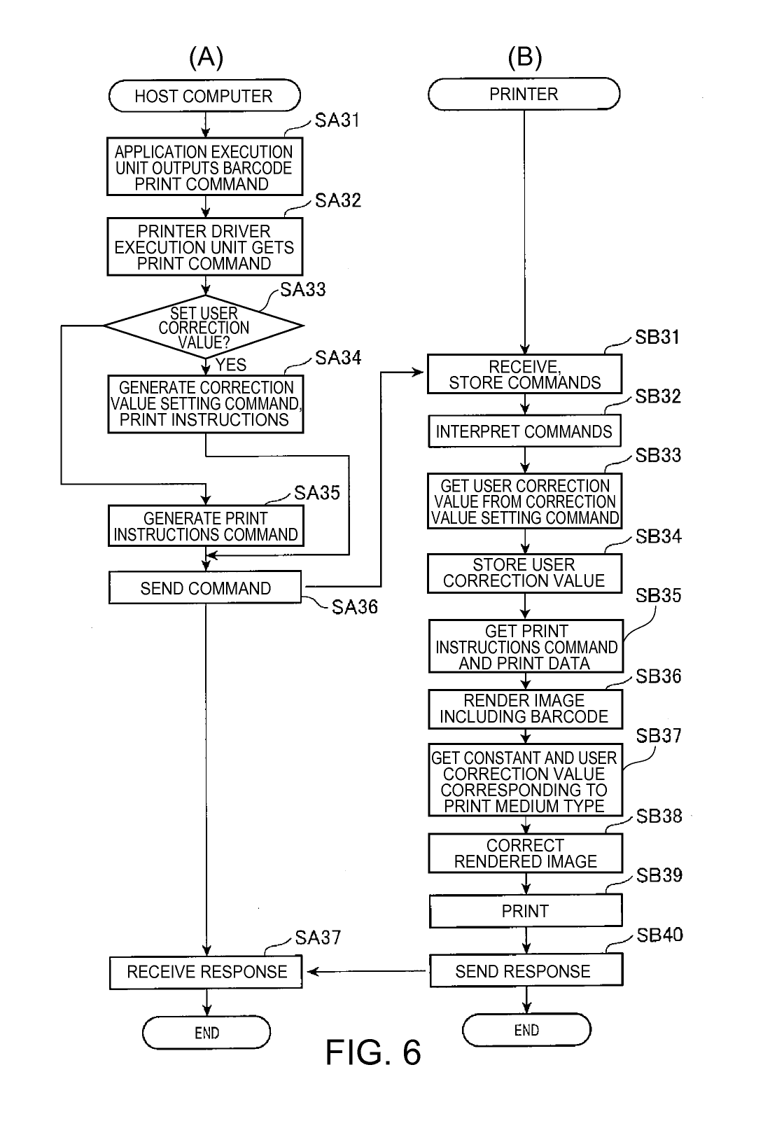

FIG. 6 is a flow chart of the operation of the printing system 8 related to setting user correction values, (A) showing the operation of the host computer 1, and (B) showing the operation of the printer 5. Note that the operation shown in FIG. 6 can obviously be executed consecutively to the operation shown in FIG. 5.

In this example, the application execution unit 45a outputs data and a print command for printing an image including a barcode to the printer driver execution unit 45b (step SA31). The printer driver execution unit 45b then acquires the data and print command input from the application execution unit 45a (step SA32). The printer driver execution unit 45b then determines if setting a user correction value 50b is commanded together with printing (step SA33). For example, a user interface of the printer driver execution unit 45b could be displayed when printing is instructed by the host computer 1. If the type of pm, inputting a user correction value, and issuing a print command are possible through this user interface, a print command and a command for setting a user correction value can be issued together.

To set a user correction value when printing (step SA33: Yes), the printer driver execution unit 45b generates a formatting command including a command to set the user correction value and a command related to printing instructions (step SA34). The plural commands generated here are an example of the command group described above.

However, if a user correction value is not set (step SA33: No), the printer driver execution unit 45b generates only a command related to printing instructions (step SA35). The commands related to printing instructions is a formatting command including, for example, a command specifying where (the field) to print the barcode described above, a command specifying the barcode, and a command specifying the end of the print area.

The command setting a user correction value here may or may not include a parameter declaring the type of print medium. The type of print medium can be declared in a parameter added to the command instructing printing, or the type of print medium used in the printer 5 may have already been set. More specifically, the operation shown in FIG. 6 can determine the type of print medium used for printing in the printer 5 without the printer driver execution unit 45b specifically declaring the type of print medium.

The printer driver execution unit 45b outputs the commands generated in steps SA34 and SA35 to the print monitor 45c, and the print monitor 45c sends the commands to the printer 5 (step SA36).

The command reception unit 27a receives and stores the commands the host computer 1 sent in the receive buffer 27e (step SB31). If the commands sent by the host computer 1 are a command group including plural formatting commands, the command reception unit 27a sequentially stores the plural commands in the command group in the receive buffer 27e. The command interpreter 27b then sequentially interprets the commands in the receive buffer 27e (step SB32), and if there is a command to set a user correction value, passes the command to the image processing unit 27d.

The image processing unit 27d then gets (step SB33) and stores the user correction value specified by the command in the printer storage unit 50 (step SB34).

If the type of print medium corresponding to the user correction value can be acquired in step SB33, the image processing unit 27d sets the user correction value in the user correction values table 50d in step SB34 relationally to the type of print medium that was acquired.

If the type of print medium corresponding to the user correction value could not be acquired in step SB33, the image processing unit 27d sets the user correction value in the user correction values table 50d in step SB34 relationally to the type of print medium used for printing. The type of print medium used for printing is declared in the commands related to printing instructions, or is preset in the printer 5. For example, the printer 5 may be configured to so that the type of print medium loaded in the printer can be automatically detected and set or set manually after the print medium is loaded.

Note that if there is not a command in the receive buffer 27e to set a user correction value, steps SB33 and SB34 are skipped.

When there is a command related to a printing instruction in the receive buffer 27e, the command interpreter 27b passes the command to the print control unit 27c. The print control unit 27c gets the commands related to printing instructions and the data for the barcode to print (step SB35). Next, the image processing unit 27d gets the barcode font based on the acquired commands and print data, and renders image data including the barcode in the print buffer 27f (step SB36).

The image processing unit 27d gets the constant identifying the type of print medium for printing and the user correction value from the printer storage unit 50 (step SB37). The image processing unit 27d then corrects the image of the barcode rendered in the print buffer 27f based on the constant and user correction value (step SB38).

The print control unit 27c converts the image data rendered in the print buffer 27f to ink volume data for the inkjet line head 12 based on the LUT, and drives the inkjet line head 12 and motor 36 to print (step SB39).

After printing is completed, the printer control unit 27 sends a response command indicating that printing ended to the host computer 1 (step SB40). The print monitor 45c receives the response command sent from the printer 5 (step SA37). This response command is a response to the settings command generated by the application execution unit 45a, or by the application execution unit 45a and the printer driver execution unit 45b. The print monitor 45c may also report to the application execution unit 45a and/or the printer driver execution unit 45b that the setting was completed.

As described above, the printer storage unit 50 in the second embodiment of the present invention stores a constants table 50c setting constants relationally to the types of print media. When a command interpreted by the command interpreter 27b is a command specifying the type of print medium and a user correction value, the image processing unit 27d sets the user correction value relationally to the type of print medium. More specifically, the image processing unit 27d gets and sets the user correction value relationally to the specified type of print medium in a user correction values table 50d. The image processing unit 27d reads the constant and user correction value corresponding to the type of print medium used for printing from the printer storage unit 50, and adjusts how to print the barcode based on the read constant and user correction value. The corrected barcode is then printed by the inkjet line head 12. As a result, if the type of print medium is declared to the printer 5 when instructing printing, a barcode can be desirably printed to reflect the constant and additional correction value (user correction value) appropriate to the type of print medium.

The present invention is described above with reference to some embodiments thereof, but the present invention is not limited thereto and can be modified and adapted in many ways without departing from the scope of the accompanying claims.

For example, the foregoing embodiments describe examples using constant and user correction values for changing the bar width of a barcode in dot units, but the present invention is not so limited. For example, these values may be used to change the amount of ink used when printing the bars of a barcode, where the ink lands, the size of the ink droplets, or other parameter.

The foregoing embodiments also use printing linear barcodes composed of bars and spaces based on a known standard such as JAN code, EAN, UPC code, ITF code, CODE39, CODE128, or NW-7, but the present invention is not so limited. For example, some embodiments of the present invention can also be used for printing QR™ codes and other two-dimensional symbol codes. In this event, when colored printed parts and spaces that are white or colorless are formed by printing, a constant and user correction value that correct the printed size of the colored printed parts can be used to handle ink bleeding.

The foregoing embodiments also describe an inkjet printer that uses four colors of ink, cyan, magenta, yellow, and black, but some embodiments of the invention can obviously also be applied to printers that use only black ink or printers that use two colors of ink such as red and black, for example.

The function blocks shown in FIG. 1 can be achieved by the cooperation of hardware and software, and do not suggest a specific hardware configuration. Functions of the host computer 1 and printer 5 could also be rendered by other devices externally connected thereto. The host computer 1 and printer 5 can also operate as described above by running programs stored on an externally connected storage medium.

The disclosure being thus described, it will be apparent that it may be varied in many ways. Such variations are not to be regarded as a departure from the spirit and scope of the disclosure, and all such modifications as would be apparent to one skilled in the art are intended to be included within the scope of the following claims.

What is claimed is:

1. A printing device comprising:
a reception unit that receives a command;
an interpreter unit that interprets commands received by the reception unit;
a print unit that prints a barcode;
a first storage unit that stores a first adjustment value adjusting how the print unit prints the barcode;
an acquisition unit that acquires a second adjustment value when a command interpreted by the interpreter unit is a command specifying the second adjustment value adjusting how the print unit prints the barcode; and
a print control unit that prints a barcode by the print unit based on the first adjustment value and the second adjustment value when the command interpreted by the interpreter unit is a command instructing printing a barcode.

2. The printing device described in claim 1, further comprising:
a receive buffer that accumulates commands received by the reception unit;
the interpreter unit sequentially interpreting commands accumulated in the receive buffer, and when a command instructing printing a barcode and a command specifying the second adjustment value are stored in the receive buffer, causing the acquisition unit to acquire the second adjustment value, and the print control unit to print the barcode based on the second adjustment value.

3. The printing device described in claim 1, further comprising:
a second storage unit that stores the second adjustment value acquired by the acquisition unit;
the print control unit printing the barcode by the print unit based on the first adjustment value stored in the first storage unit and the second adjustment value stored in the second storage unit when a command interpreted by the interpreter unit is a command instructing printing a barcode.

4. The printing device described in claim 3, wherein:
the first storage unit stores the first adjustment value relationally to a type of print medium;
the acquisition unit acquires and stores the second adjustment value in the second storage unit relationally to the specified type of print medium when a command interpreted by the interpreter unit is a command specifying a type of print medium and the second adjustment value; and
the print control unit reads the first adjustment value and second adjustment value related to the type of print medium printed by the print unit from the first storage unit and the second storage unit, and prints a barcode based on the first adjustment value and second adjustment value that were read.

5. The printing device described in claim 1, wherein:
the command specifying the second adjustment value is a command having a parameter that declares the second adjustment value within a predefined numeric range.

6. The printing device described in claim 1, wherein:
the first adjustment value stored in the first storage unit, and the second adjustment value specified by a command, are values indicating a correction amount for the width of bars in the barcode printed by the print unit.

7. A printing system including a printing device and a communicatively connected print control device, wherein:
the print control device sends commands to the printing device; and
the printing device includes a reception unit that receives commands sent from the print control device,
an interpreter unit that interprets commands received by the reception unit,
a print unit that prints a barcode,
a first storage unit that stores a first adjustment value adjusting how the print unit prints the barcode,
an acquisition unit that acquires a second adjustment value when a command interpreted by the interpreter unit is a command specifying the second adjustment value adjusting how the print unit prints the barcode, and
a print control unit that prints a barcode by the print unit based on the first adjustment value stored in the first storage unit and the second adjustment value acquired by the acquisition unit when the command interpreted by the interpreter unit is a command instructing printing a barcode.

8. A control method of a printing device, comprising:
storing a first adjustment value adjusting how the print unit prints the barcode;
receiving a command;
interpreting the received command;
acquiring a specified second adjustment value when the interpreted command is a command specifying a second adjustment value adjusting how to print the barcode; and
printing a barcode based on the first adjustment value and the second adjustment value when the interpreted command is a command instructing printing a barcode.

9. The control method of a printing device described in claim 8, further comprising:
accumulating received commands;
sequentially interpreting accumulated commands;
acquiring the second adjustment value when the interpreted command is a command instructing printing a barcode and a command specifying the second adjustment value; and
printing the barcode based on the second adjustment value.

10. The control method of a printing device described in claim 8, further comprising:
storing the acquired second adjustment value; and
printing the barcode based on the first adjustment value and the second adjustment value when the interpreted command is a command instructing printing a barcode.

11. The control method of a printing device described in claim 10, further comprising:
storing the first adjustment value relationally to a type of print medium;
acquiring and storing the second adjustment value relationally to the specified type of print medium when the interpreted command is a command specifying a type of print medium and the second adjustment value; and
reading the first adjustment value and second adjustment value related to the type of print medium, and printing a barcode based on the first adjustment value and second adjustment value that were read.

12. The control method of a printing device described in claim 8, wherein:
the command specifying the second adjustment value is a command having a parameter that declares the second adjustment value within a predefined numeric range.

13. The control method of a printing device described in claim 8, wherein:
the first adjustment value and the second adjustment value are values indicating a correction amount for the width of bars in the barcode to be printed.
